(19) United States
(12) Patent Application Publication
(10) Pub. No.: US 2011/0005402 A1
(43) Pub. Date: Jan. 13, 2011

(54) HEATING CONTROL STRUCTURE OF FOOD PROCESSOR

(76) Inventor: Hcin-I HUANG, Antin Shiang (TW)

Correspondence Address: Dr. BANGER SHIA;Patent Office of Bang Shia, 102 Lindencrest Ct, Sugar Land, TX, 77479-5201, US

(21) Appl. No.: 12/830,422

(22) Filed: Jul. 5, 2010

(30) Foreign Application Priority Data
Jul. 7, 2009 (CN) CN200920059933.2

(51) Int. Cl. A47J 36/24

(52) U.S. Cl. 99/331

(57) ABSTRACT

A heating control structure of a food processor includes a cup body, a cutter disposed in the cup body, a heating disk, a heating tube, a temperature sensor, a temperature switch and a fixing seat. The temperature sensor and the temperature switch are attached to an upper surface of the fixing seat. A lower surface of the fixing seat is connected with power connecting feet and temperature transmitting feet. Upper ends of the power connecting feet are connected to the temperature switch. Upper ends of the temperature transmitting feet are connected to the temperature sensor. The temperature sensor, the temperature switch, the power connecting feet and the temperature transmitting feet are fixed to the fixing seat. To assemble the present invention, they are first mounted on the fixing seat and their connecting wires are also connected with each other. After that, the fixing seat is mounted in the cup body, so that a modular assembly is completed. This is beneficial to simplify production, enhance efficiency and lower fraction defective.

### BACKGROUND OF THE INVENTION

1. Field of the Invention

The present invention relates to a food processor, and more particularly to a heating control structure of a food processor.

2. Description of the Prior Art

A food processor is a small electric appliance used for making soybean milk, paste or juice. Standard of living is continuously increasing along with the economic develop. This food processor is a convenient, practical and hygienic processing apparatus in the kitchen, which is more and more popular.

The food processor essentially comprises a driving control unit, a heating control unit, a cup body and a cutter. The driving control unit comprises an electric machine, a transformer, a control circuit board, and so on. The heating control unit comprises a heating tube, a temperature switch, a temperature sensor, and so on. In order to avoid the electronic components in the driving control unit from being influenced by the temperature and humidity in the cup body, the driving control unit is disposed in a base which is detachable from the cup body. The cutter and the heating control unit are disposed in the cup body. The electric machine drives the cutter to cut, smash or mix the food for processing. During processing, the cup body is heated by the heating tube of the heating control unit for heating the food in the cup body.

However, the conventional food processer has some shortcomings in its structure and use function. In particular, the positions of the temperature switch and the temperature sensor of the heating control unit are not appropriate to cause the difficulty in assembly, which extends the work time, influences the production efficiency, and increases the cost.

### SUMMARY OF THE INVENTION

The primary object of the present invention is to provide a heating control structure of a food processor, which is compact and convenient to assemble so as to improve the shortcomings of the prior art.

In order to achieve the aforesaid object, there is provided a heating control structure of a food processor comprising a cup body, a cutter disposed in the cup body, a heating disk, a heating tube, a temperature sensor and a temperature switch. The cup body has a raised section extending from a central portion of a bottom thereof. The cutter is fixed to a central portion of the raised section. The heating disk is fixed to the raised section as the bottom of the cup body. A circumferential edge of the heating disk is hermetically sealed to an inner wall of the cup body. The heating disk, the raised section, an inner bottom side of the cup body and the inner wall of the cup body form an annular chamber. The heating tube is disposed in the annular chamber and attached to a bottom surface of the heating disk. The food processor further comprises a fixing seat. The fixing seat is disposed in the annular chamber. The temperature sensor and the temperature switch are attached to an upper surface of the fixing seat. Upper surfaces of the temperature sensor and the temperature switch are contact with the heating disc. A lower surface of the fixing seat is connected with power connecting feet and temperature transmitting feet. Upper ends of the power connecting feet are connected to the temperature switch. Upper ends of the temperature transmitting feet are connected to the temperature sensor. Lower ends of the power connecting feet and the temperature transmitting feet extend out of the bottom side of the cup body.

Preferably, the fixing seat has a crescentic shape.

Preferably, the fixing seat is attached to the bottom surface of the heating disk.

Preferably, the fixing seat is located at an opening of the heating tube.

The feature of the present invention is that the temperature sensor, the temperature switch, the power connecting feet and the temperature transmitting feet are fixed to the fixing seat through a suitable arrangement. To assemble the present invention, they are first mounted on the fixing seat and their connecting wires are also connected with each other. After that, the fixing seat is mounted in the cup body, so that a modular assembly is completed. This is beneficial to simplify production, enhance efficiency and lower fraction defective.

### BRIEF DESCRIPTION OF THE DRAWINGS

FIG. 1 is a cross-sectional view according to a preferred embodiment of the present invention;

FIG. 2 is a perspective view according to the preferred embodiment of the present invention;

FIG. 3 is a partially enlarged view according to the preferred embodiment of the present invention;

FIG. 4 is a bottom view of FIG. 3; and

FIG. 5 is an exploded view of FIG. 3.

### DETAILED DESCRIPTION OF THE PREFERRED EMBODIMENTS

Embodiments of the present invention will now be described, by way of example only, with reference to the accompanying drawings.

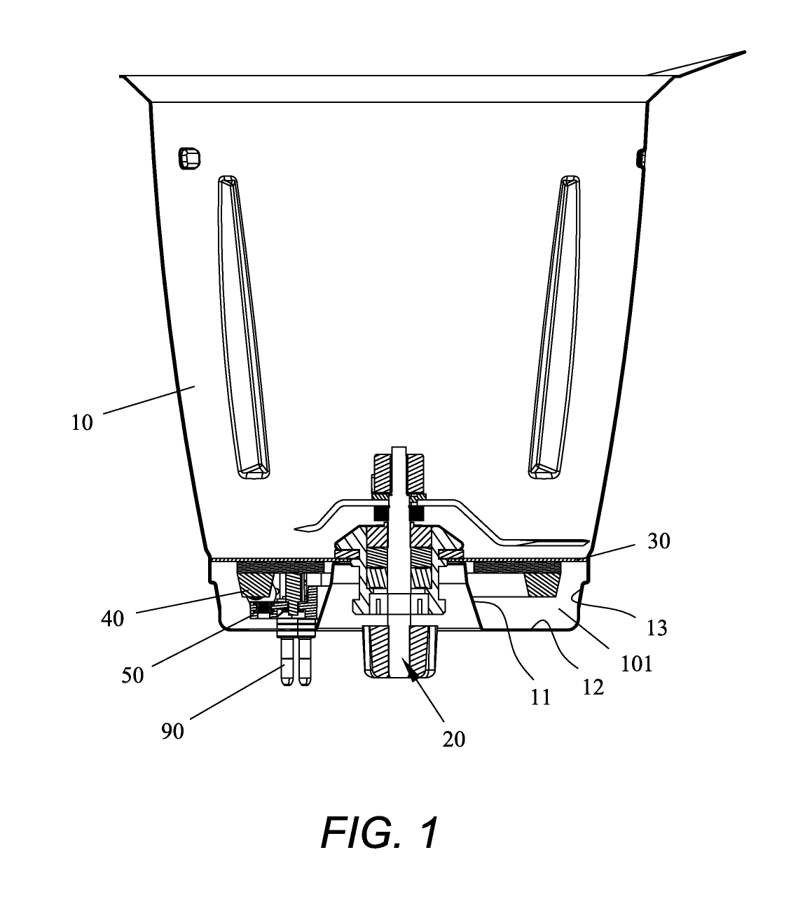

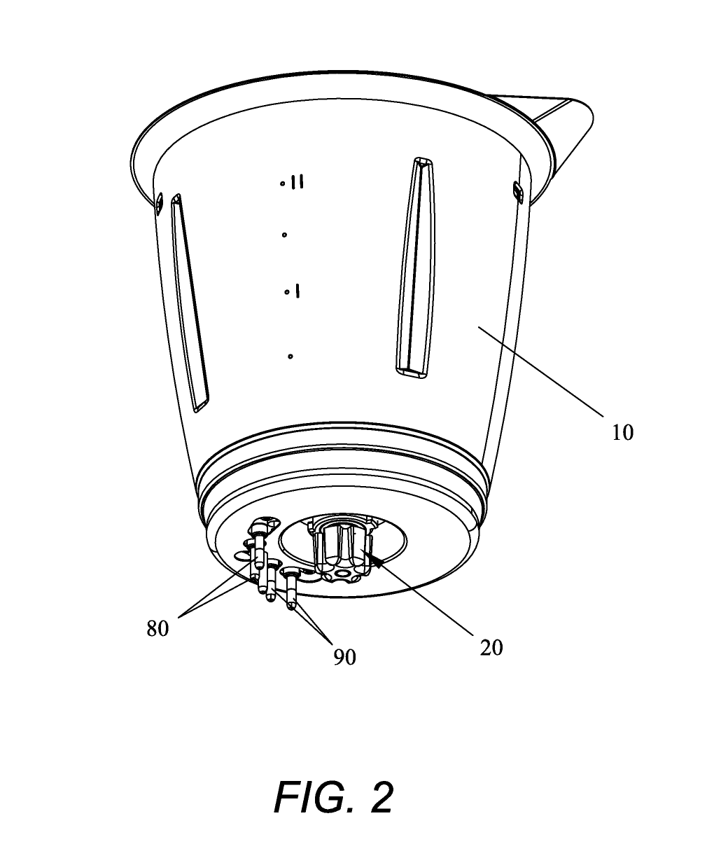

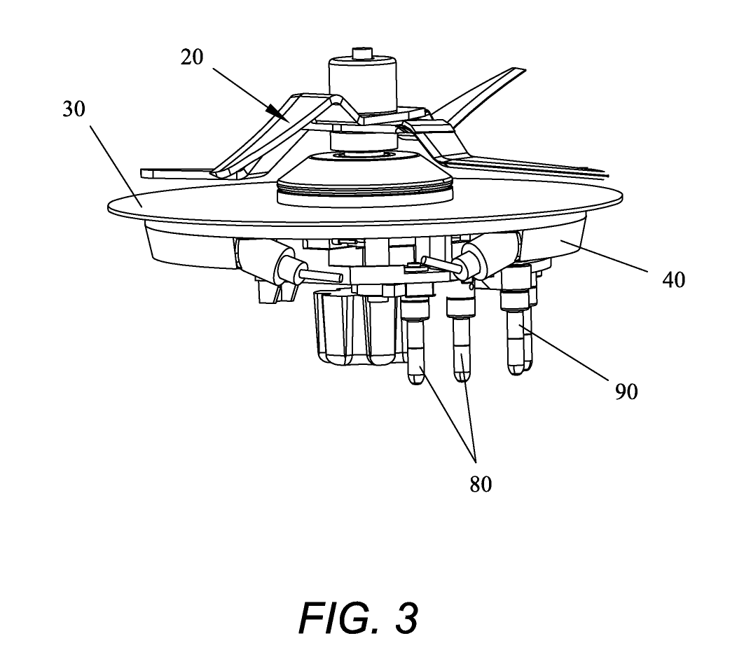

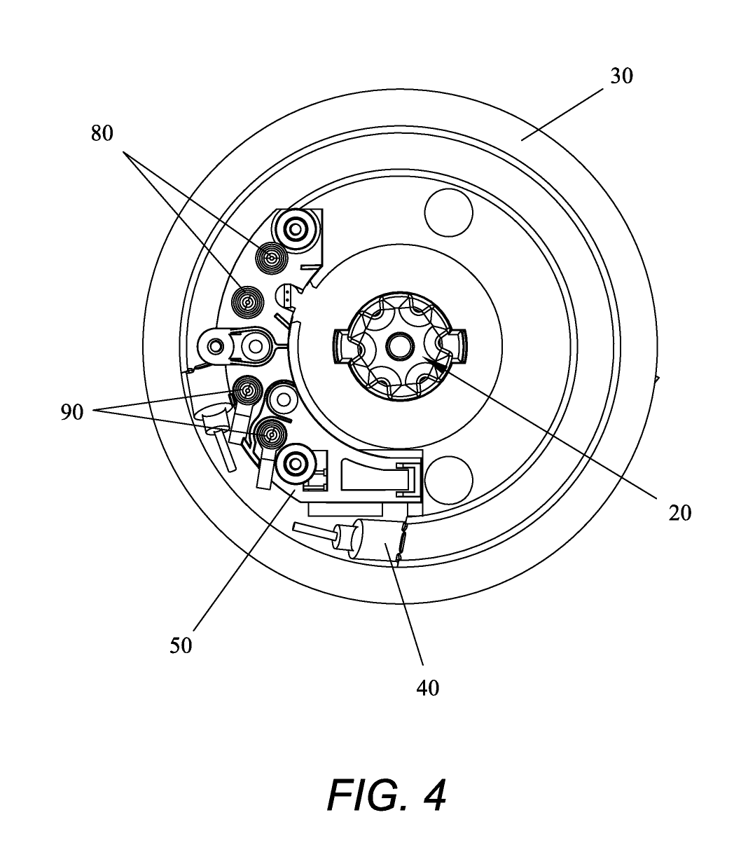

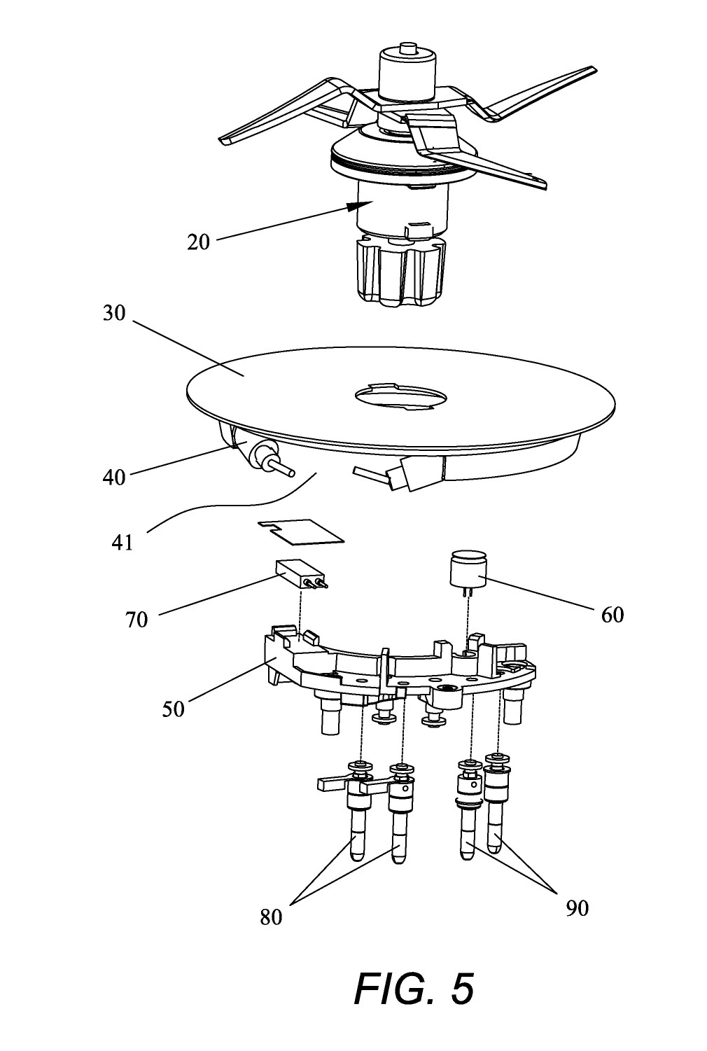

As shown in FIG. 1 to FIG. 5, a preferred embodiment of the present invention comprises a cup body 10, a cutter 20 disposed in the cup body 10, a heating disk 30, a heating tube 40, a fixing seat 50, a temperature sensor 60, a temperature switch 70, power connecting feet 80, and temperature transmitting feet 90.

The cup body 10 has a raised section 11 extending from a central portion of a bottom thereof. The cutter 20 is fixed to a central portion of the raised section 11. The heating disk 30 is fixed to the raised section 11 as the bottom of the cup body 10. A circumferential edge of the heating disk 30 is hermetically sealed to an inner wall 13 of the cup body 10. The heating disk 30, the raised section 11, an inner bottom side 12 of the cup body 10 and the inner wall 13 of the cup body 10 form an annular chamber 101.

The heating tube 40 is disposed in the annular chamber 101 and attached to a bottom surface of the heating disk 30.

The fixing seat 50 has a crescentic shape. The fixing seat 50 is also disposed in the annular chamber 101 and attached to the bottom surface of the heating disk 30. Preferably, the fixing seat 50 is located at an opening 41 of the heating tube 40.

The temperature sensor 60 and the temperature switch 70 are attached to an upper surface of the fixing seat 50. Upper surfaces of the temperature sensor 60 and the temperature switch 70 are contact with the heating disc 30.

The power connecting feet 80 and the temperature transmitting feet 90 are attached to a lower surface of the fixing seat 50. Upper ends of the power connecting feet 80 are connected to the temperature switch 70 through conducting wires. Upper ends of the temperature transmitting feet 90 are connected to the temperature sensor 60 through conducting wires. Lower ends of the power connecting feet 80 and the temperature transmitting feet 90 extend out of the bottom side of the cup body 10 for connecting with the a circuit board of a base, not shown in the drawings.

The feature of the present invention is that the temperature sensor, the temperature switch, the power connecting feet and the temperature transmitting feet are fixed to the fixing seat through a suitable arrangement. To assemble the present invention, they are first mounted on the fixing seat and their connecting wires are also connected with each other. After that, the fixing seat is mounted in the cup body, so that a modular assembly is completed. This is beneficial to simplify production, enhance efficiency and lower fraction defective.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A heating control structure of a food processor, comprising a cup body, a cutter disposed in the cup body, a heating disk, a heating tube, a temperature sensor and a temperature switch, the cup body having a raised section extending from a central portion of a bottom thereof, the cutter being fixed to a central portion of the raised section, the heating disk being fixed to the raised section as the bottom of the cup body, a circumferential edge of the heating disk being hermetically sealed to an inner wall of the cup body, the heating disk, the raised section, an inner bottom side of the cup body and the inner wall of the cup body forming an annular chamber, the heating tube being disposed in the annular chamber and attached to a bottom surface of the heating disk, and characterized by: the heating control structure further comprising a fixing seat, the fixing seat being disposed in the annular chamber, the temperature sensor and the temperature switch being attached to an upper surface of the fixing seat, upper surfaces of the temperature sensor and the temperature switch being contact with the heating disc, a lower surface of the fixing seat being connected with power connecting feet and temperature transmitting feet, upper ends of the power connecting feet being connected to the temperature switch, upper ends of the temperature transmitting feet being connected to the temperature sensor, lower ends of the power connecting feet and the temperature transmitting feet extending out of the bottom side of the cup body.

2. The heating control structure of a food processor as claimed in claim 1, wherein the fixing seat has a crescentic shape.

3. The heating control structure of a food processor as claimed in claim 1, wherein the fixing seat is attached to the bottom surface of the heating disk.

4. The heating control structure of a food processor as claimed in claim 1, wherein the fixing seat is located at an opening of the heating tube.
